(19) United States
(12) Patent Application Publication
(10) Pub. No.: US 2011/0308895 A1
(43) Pub. Date: Dec. 22, 2011

(54) ELEVATOR SAFETY DEVICE

(75) Inventors: Anying Shen, Bloomington, IN (US); William S. Mattox, JR., Jasonville, IN (US)

(73) Assignee: Otis Elevator Company, Farmington, CT (US)

(21) Appl. No.: 13/148,707

(22) PCT Filed: Feb. 25, 2009
(86) PCT No.: PCT/US09/35075

§ 371 Date: Aug. 10, 2011

(51) Int. Cl. B66B 5/18; B66B 3/00; B66B 5/22

(52) U.S. Cl. 187/359; 187/393

(57) ABSTRACT

An exemplary elevator safety device includes a housing. A brake member is moveably supported by the housing for selective movement between a disengaged position and a braking position. A sensor is supported by the housing and detects movement of the brake member into the braking position.

### BACKGROUND

Elevator systems are useful for carrying passengers, cargo or both between various levels of a building. The speed at which an elevator car moves depends upon operation of the machine (e.g., motor and brake). When the system is functioning as expected, machine operation results in a desired elevator car speed.

There are various conditions during which an elevator car may move faster than desired. There are known devices for detecting such over speed conditions. For example, governors are useful for monitoring elevator car speed. Under some conditions, a governor will trigger a safety braking operation to bring the elevator car to a stop.

Elevator safety devices provide a braking function that is separate from the braking capability of the machine (e.g., the machine brake). Such elevator safety devices typically include a brake member that directly engages a surface on the guiderails along which the elevator car moves. There are various known elevator safety device configurations.

One aspect of utilizing elevator safety devices for stopping the elevator car includes providing some indication that the safety device has engaged the guiderail. This is useful to initiate stopping the machine so that it does not attempt to continue to move the elevator car.

Current arrangements include a switch and a cam attached to a moving part along the linkage that is associated with the governor for moving the braking element of the safety device into a braking position. For example, a switch may be attached to the crosshead of an elevator car frame with a cam bracket associated with a connecting rod that moves responsive to operation of the governor. As the governor rope pulls on the linkage to engage the safety braking element with the guiderail, the switch detects motion of the connecting rod of the linkage through the cam. In this manner the switch is able to provide a signal to the machine controller for stopping the machine.

One drawback associated with this approach is that it requires field adjustment. Installation and adjustment is time consuming and subject to human error. Secondly, there are conditions in which the switch does not provide a true indication of the condition of the safety device. For example, it is possible for the crosshead linkage to reset even though the braking element of the safety device is not reset. In some cases, it is possible for the braking element of the safety device to be engaged with the guiderail even though the safety device has not been activated by the governor.

### SUMMARY

An exemplary elevator safety device includes a housing. A brake member is moveably supported by the housing for selective movement between a disengaged position and a braking position. A sensor is supported by the housing and detects movement of the brake member into the braking position.

An exemplary method of monitoring an elevator safety device includes providing a sensor on the housing of the safety device. A determination is made when the brake member has moved into the braking position responsive to an indication from the sensor.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 is a perspective illustration of an example elevator safety device designed according to an embodiment of this invention.

FIG. 3 is a cross-sectional view taken along the lines 3-3 in FIG. 2.

FIGS. 4A and 4B schematically illustrate two operating conditions of another example sensor device.

FIG. 5 schematically illustrates another example sensor device.

### DETAILED DESCRIPTION

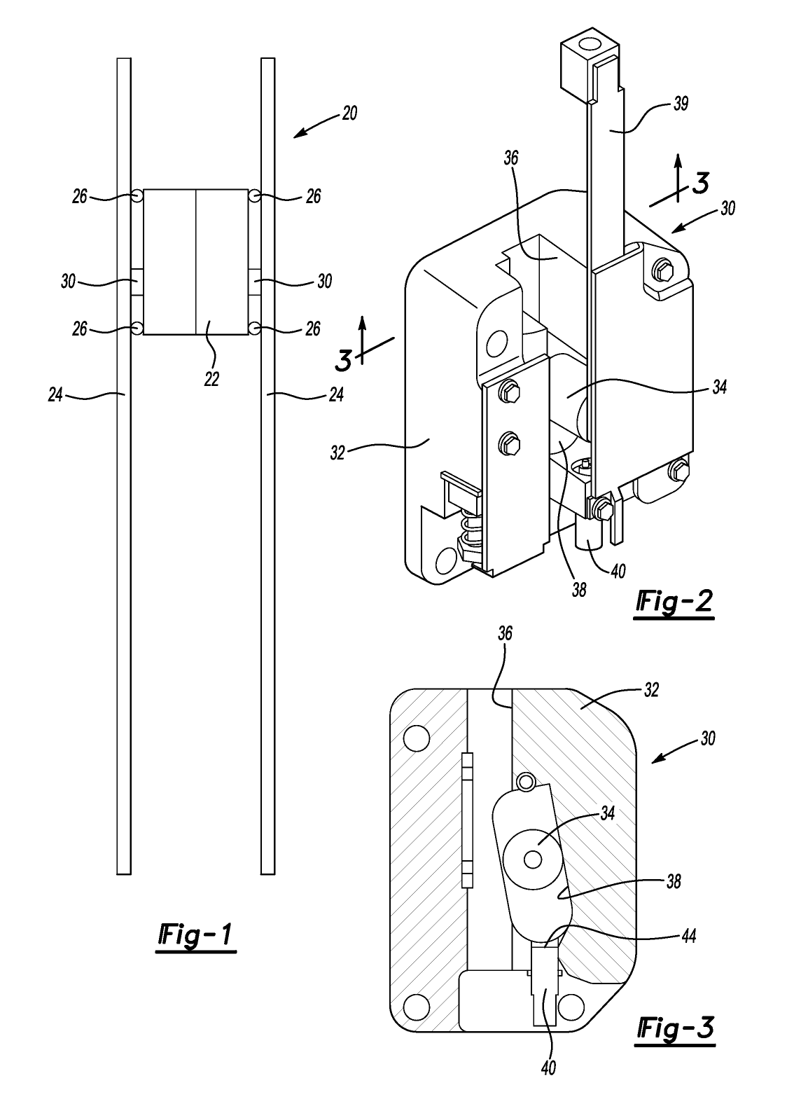

FIG. 1 schematically shows selected portions of an elevator system 20. An elevator car 22 moves along guiderails 24 responsive to operation of a machine (e.g., motor and brake) (not illustrated). Elevator guides 26 facilitate movement of the car 22 along the guiderails 24 in a known manner.

Elevator safety devices 30 are supported for movement with the elevator car 22 and are selectively operated to stop the elevator car 22.

Referring to FIGS. 2 and 3, one example safety device 30 includes a housing 32. A brake member 34 is supported by the housing 32 so that the brake member 34 is selectively engaged with a corresponding portion of a guiderail 24 that is received within a channel 36 formed in the housing 32. The brake member 34 follows a contour 38 formed on the housing 32 as the brake member 34 moves between a disengaged position in which the brake member 34 does not contact the guiderail 24 and a braking position in which the brake member 34 engages the guiderail 24 to cause the elevator car 22 to stop. As shown in FIG. 2, a link 39 is used for coupling the brake member 34 to a governor actuating mechanism for purposes of moving the brake member 34 into the braking position when desired.

The example safety device 30 includes a sensor 40 supported by the housing 32. The sensor 40 detects the position of the brake member 34 and provides an indication when the brake member 34 moves into the braking position.

In the example of FIGS. 2 and 3, the brake member 34 comprises a roller and is illustrated in a braking position. The sensor 40 includes a portion 44 within the housing 32 for detecting when the brake member 34 is in the braking position. In this example, the sensor 40 comprises a proximity sensor that detects when a distance from the portion 44 and the brake member 34 is great enough to provide an indication that the brake member 34 has moved into the braking position (i.e., away from the switch portion 44). A known proximity sensor is used in one example.

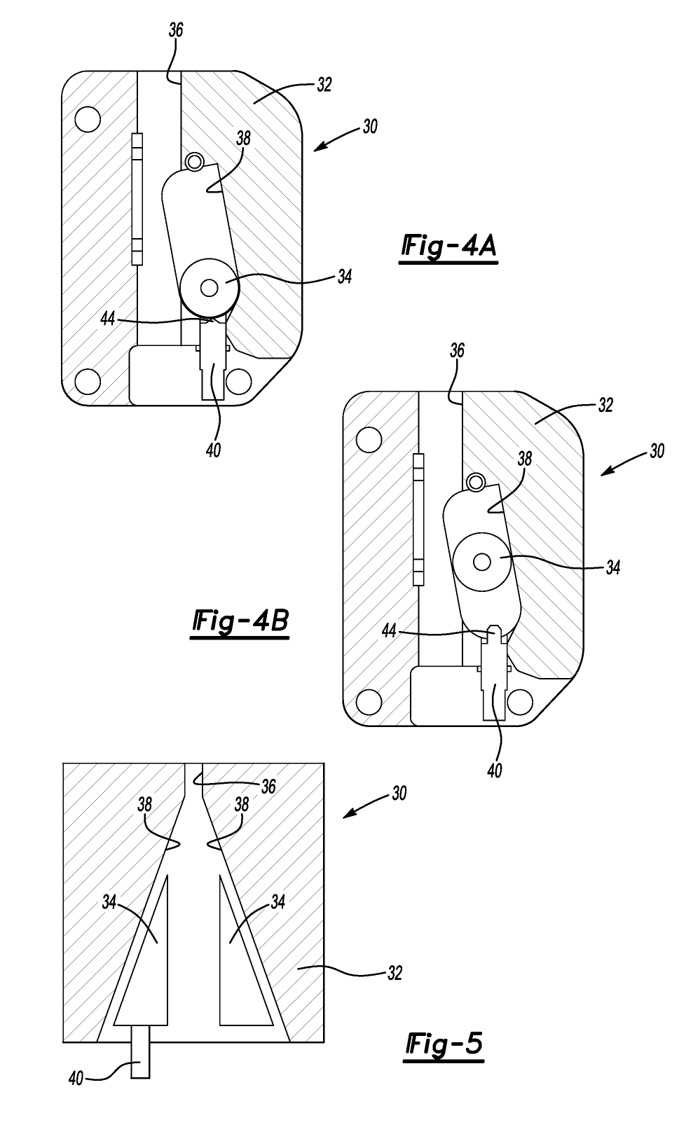

FIGS. 4A and 4B illustrate another example arrangement where the sensor 40 comprises a limit switch. In this example, the portion 44 of the sensor 40 supported within the housing 32 comprises a plunger that moves responsive to the presence or absence of the brake member 34 adjacent the sensor 40. In this example, as shown in FIG. 4A, the mass of the brake member 34 rests upon the plunger 44 moving it downward (according to the drawing). When the brake member 34 is moved into the braking position as shown in FIG. 4B, the plunger 44 moves relative to another portion of the sensor 40 and activates the switch so that the sensor 40 provides an indication that the brake member 34 has moved into the braking position.

FIG. 5 illustrates another example safety device arrangement in which there are a plurality of brake members 34. In this example, the brake members 34 are wedge-shaped. At least one sensor 40 is provided for detecting the position of at least one of the brake members 34.

In each of the example safety devices, the sensor 40 is supported by the housing 32 such that a portion of the sensor 40 is positioned relative to the housing 32 in a location where it can directly detect the position of the brake member 34. This allows for the sensor 40 to provide a direct indication of the position of the brake member 34. This is an improvement over arrangements that rely upon detecting an orientation or condition of a linkage member associated with activating an elevator safety device. By directly detecting the position of the brake member 34, the illustrated examples provide a more accurate and reliable indication regarding the condition of the safety device 30 and, in particular, the position of the brake member 34.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An elevator safety device, comprising:
a housing;
a brake member moveably supported at least partially within the housing for selective movement between a disengaged position and a braking position; and
a sensor supported at least partially within the housing that detects movement of the brake member into the braking position.

2. The device of claim 1, wherein the sensor comprises a switch that provides an indication when the brake member moves into the braking position.

3. The device of claim 2, wherein the switch has a portion within the housing in close proximity to the brake member when the brake member is in the disengaged position.

4. The device of claim 3, wherein the portion of the switch is activated responsive to movement of the brake member into the braking position.

5. The device of claim 3, wherein the portion of the switch is activated responsive to a loss of contact with the brake member.

6. The device of claim 2, wherein the switch comprises a limit switch.

7. The device of claim 2, wherein the switch comprises a proximity switch.

8. The device of claim 1, wherein the brake member comprises a roller.

9. The device of claim 1, wherein the brake member comprises a plurality of wedges and the sensor detects movement of at least one of the wedges.

10. The device of claim 1, wherein the brake member is configured to engage a guide rail in the braking position.

11. A method of monitoring an elevator safety device that has a brake member supported by a housing for selective movement between a disengaged position and a braking position, comprising the steps of:
providing a sensor at least partially within the housing; and
determining when the brake member has moved into the braking position responsive to an indication from the sensor.

12. The method of claim 11, wherein the sensor comprises a switch that provides the indication when the brake member moves into the braking position.

13. The method of claim 12, comprising providing the indication responsive to movement of the brake member into the braking position.

14. The method of claim 12, comprising providing the indication responsive to a loss of contact between a portion of the switch and the brake member.

15. The method of claim 11, wherein the brake member is configured to engage a guide rail in the braking position.
